(19) United States
(12) Patent Application Publication
(10) Pub. No.: US 2005/0011535 A1
(43) Pub. Date: Jan. 20, 2005

(54) Cleaning semiconductor wafers

(76) Inventors: Randy Skocypec, Gilbert, AZ (US); Hosseyn T. Nuri, Chandler, AZ (US); Brian Weselak, Beaverton, OR (US)

Correspondence Address: Timothy N. Trop;TROP, PRUNER & HU, P.C., STE 100, 8554 KATY FWY, HOUSTON, TX, 77024-1841, US

(21) Appl. No.: 10/622,307

(22) Filed: Jul. 18, 2003

(51) Int. Cl. B08B 7/00

(52) U.S. Cl. 134/6; 134/34; 134/184; 134/198; 15/21.1

(57) ABSTRACT

A wafer that has been subjected to chemical mechanical polishing may be cleaned by positioning it between a pair of counter-rotating brushes. A cleaning solution is applied through the center of the brushes as the brushes rotate. As a result, in some embodiments, wafer defect density may be reduced, cleaning chemical residue buildup can be reduced, brush lifetime may be increased, and cleaning effectiveness may be improved.

### BACKGROUND

This invention relates generally to methods and apparatus for cleaning semiconductor wafers.

Chemical mechanical processing is an abrasive process which removes a uniform layer of material from a semiconductor wafer. After chemical mechanical polishing, it is desirable to clean the wafer to remove any of the polishing slurry and any of the remaining debris.

Conventionally, the post polishing clean is accomplished using a pair of rotating brushes. The wafer is positioned between the counter-rotating brushes. A chemical solution is sprayed (Dispensed may be a better word here as the chemical can be ‘sprayed’, or ‘driped’ from the nozzles depending on flow rate) from nozzles onto the wafer and/or the brushes.

One problem with this approach is that the nozzles that spray the chemical are subject to fouling from cleaning chemical residues.

Another problem with existing techniques is that the overspray of the cleaning chemical results in a large amount of wasted chemical. In addition to the extra expense, residue buildup becomes a source of wafer contamination.

Still another problem is that the cleaning chemical that is dispensed is non-uniformly distributed across the brush wafer interface. This results in ineffective cleaning and more waste of the chemical. It also results in additional chemical buildup in the process environment, causing process defects.

Thus, there is a need for better ways to clean wafers after chemical mechanical polishing.

### BRIEF DESCRIPTION OF THE DRAWINGS

FIG. 1 is a top plan view of one embodiment of the present invention; and

FIG. 2 is a cross-sectional view taken generally along the line 2-2 in FIG. 1.

### DETAILED DESCRIPTION

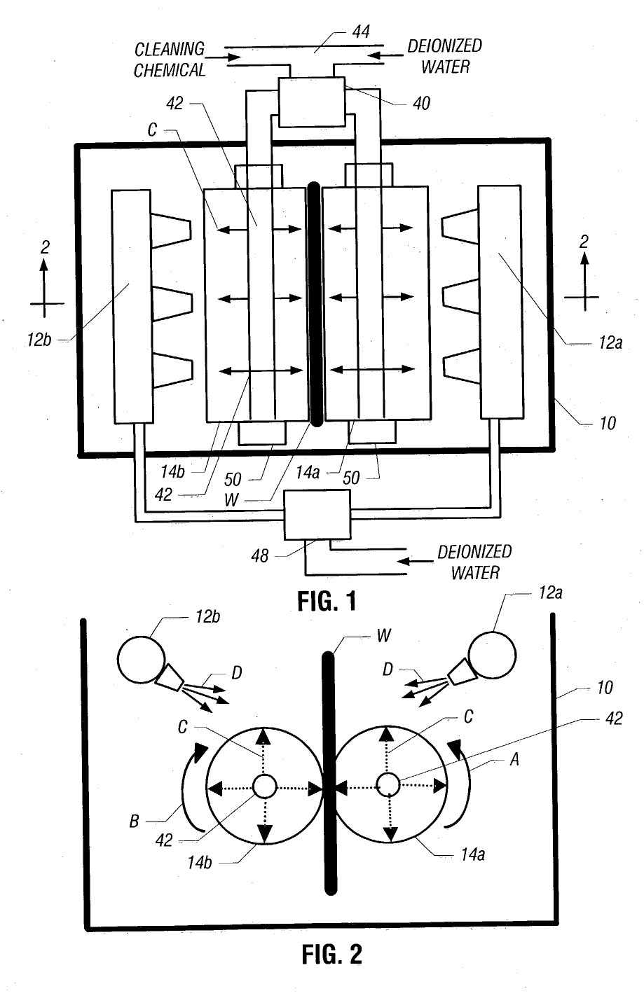

Referring to FIG. 1, a wafer W may be positioned within a post-chemical mechanical polishing cleaning apparatus 10. The apparatus 10 includes a pair of spray bars 12a and 12b and a pair of counter-rotating brushes 14a and 14b. The wafer is positioned between and in contact with each of the brushes 14.

The spray bars 12 are coupled to a source of the deionized water and a pump 48 so that the deionized water may be sprayed at the wafer brush interface. In addition, the source of deionized water and a suitable cleaning chemical may be mixed by a mixer 44 and provided to a pump 40. From the pump 40, the cleaning solution of mixed chemical and deionized water is supplied to the interior of the brushes 14 through the pipes 42. Other cleaning solutions may also be used. As a result, as indicated by the arrows C, the cleaning solution is ejected outwardly from the center of each brush 14 towards its periphery and, particularly, towards the brush wafer interface.

Thus, referring to FIG. 2, it can be seen that the pipe 42 supplies the cleaning solution so that it extends outwardly in all directions in a radial configuration through the brushes 14. In one embodiment, the pipe 42 may be provided with a suitable circumferential array of apertures to evenly dispense the cleaning solution from the pipe 42. In one embodiment, the brushes 14 may be rotated around the pipe 42. As the brushes 14 rotate, as indicated by the arrows A and B, the cleaning solution is applied to the brush wafer interface. At the same time, the spray bars 12 spray deionized water, indicated by the arrows D, at the brush wafer interface.

In one embodiment, the brushes 14 may be rotated by motors 50. In another embodiment, the brushes 14 may be rotated by the way in which the cleaning solution is ejected from the pipe 42.

In some embodiments of the present invention, the buildup of residue from the chemical on the spray bars 12a and 12b is reduced or eliminated because the spray bars 12a and 12b only spray deionized water The cleaning solution is more effectively dispensed at the brush wafer interface, in some embodiments, because of the injection through the center of the brushes 14. This may reduce overspray of chemical and waste of chemical, while providing more effective cleaning and improving the lifetime of the brushes themselves in some embodiments. In addition, residue buildup may be avoided. The more effective use of the cleaning solution may result in reduced wafer contamination from the cleaning solution.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
positioning a wafer between a pair of rotating brushes; providing a cleaning solution through at least one of said brushes; and
spraying a solution at the interface between said rotating brushes and said wafer.

2. The method of claim 1 including providing a cleaning solution through the center of each of said brushes.

3. The method of claim 1 wherein providing a cleaning solution includes providing a solution of deionized water and a cleaning chemical.

4. (Canceled).

5. The method of claim 1 including using a spray bar to spray the solution.

6. The method of claim 5 including spraying the deionized water at the interface between the brushes and wafers.

7. The method of claim 1 including providing the cleaning solution to both of said brushes.

8. The method of claim 1 including cleaning wafers after chemical mechanical polishing.

9. An apparatus comprising:
a pair of rotatable brushes to receive a wafer between said brushes; and
a cleaning solution dispenser to dispense cleaning solution from the interior of said brushes and to flow outwardly through the brushes to the brush wafer interface.

10. The apparatus of claim 9 including spray bars to spray liquid at the brush wafer interface.

11. The apparatus of claim 10 wherein said spray bars are coupled to a source of deionized water.

12. The apparatus of claim 9 including a reservoir to supply a source of cleaning solution.

13. The apparatus of claim 12 including a mixer to mix deionized water and a cleaning chemical to form the cleaning solution.

14. The apparatus of claim 9 including a pipe that provides a cleaning solution to the center of each of said brushes and ejects said cleaning solution radially outwardly through said brushes.

15. An apparatus for cleaning semiconductor wafers after chemical mechanical polishing comprising:
a pair of counter-rotating brushes to receive a wafer to be cleaned between said brushes;
a pair of spray bars to spray deionized water at the brush wafer interface; and
a cleaning solution dispenser to dispense cleaning solution from the center of each of said brushes to flow outwardly through the brushes to the brush wafer interface.

16. The apparatus of claim 15 including a mixer to mix deionized water and a cleaning chemical to form a cleaning solution.

17. The apparatus of claim 15 including a pipe that extends through each of said brushes to dispense the cleaning solution from the center of said brushes.
